(19) United States
(12) Patent Application Publication
(10) Pub. No.: US 2010/0198372 A1
(43) Pub. Date: Aug. 5, 2010

(54) System and Method for Generating Control Logic

(76) Inventor: Ketan P. Mehta, Sugar Land, TX (US)

Correspondence Address: STRASBURGER & PRICE, LLP;ATTN: IP SECTION, 1401 MCKINNEY, SUITE 2200, HOUSTON, TX, 77010, US

(21) Appl. No.: 12/608,639

(22) Filed: Oct. 29, 2009

Related U.S. Application Data
(60) Provisional application No. 61/197,753, filed on Oct. 30, 2008.

(51) Int. Cl. G05B 15/02; G05B 9/02

(52) U.S. Cl. 700/80; 700/86; 700/83

(57) ABSTRACT

A computer implemented method and system will generate the control logic for a control system application based on the process data input into the system in a series of easy to understand forms and steps.

### CROSS-REFERENCE TO RELATED APPLICATIONS

This application claims the benefit of U.S. Provisional Application No. 61/197,753 filed on Oct. 30, 2008, which application is hereby incorporated by reference for all purposes in its entirety.

### STATEMENT REGARDING FEDERALLY SPONSORED RESEARCH OR DEVELOPMENT

N/A

### REFERENCE TO MICROFICHE APPENDIX

N/A

### BACKGROUND OF THE INVENTION

1. Field of the Invention

The present invention relates to industrial plant automation.

2. Description of the Related Art

Many companies provide Digital Control Systems (DCS) technology for Plant Automation. The DCS has to be programmed by a Control Systems Engineer (CSE) who is familiar with the process requirements, the piping and instrument design of the plant, and the operating specifications of the individual components/machines that are used in the process. The CSE has to be educated and made proficient in the programming interfaces and methodologies of the DCS. Although the industry has standardized the programming languages by way of specifications similar to IEC-61131 (ladder logic diagrams or structured function charts or function block diagrams), the CSE is still required to understand the general programming strategies and details of the function blocks available in the DCS. In typical scenarios, the CSE is intimately familiar with the process that is to be automated, but he or she lacks the knowledge to encode this into a control program that can be compiled or assembled and executed by the control system.

It would be desirable to automatically generate the control logic for the control system based upon process data input into a series of easy to understand data entry forms.

### BRIEF SUMMARY OF THE INVENTION

A computer software program is generated in a programming language with a graphical user interface design tool. The computer software may be used by a CSE who is tasked with automating a process. The computer software program presents the user with a series of easy-to-understand data entry forms in a defined sequence. These forms allow the CSE to enter the relevant process data including transmitter ranges, settings at which alarms are to be generated, machine information (such as compressor performance curve as provided by the compressor manufacturer, or the boiler air-flow characteristics, and similar machine information), and other necessary process data.

In addition to allowing the CSE to enter detailed process data, the data entry screens allow the CSE to select if certain optional process equipment is present for that type of application and if control logic is to be generated for those options. For example, in one application, the CSE can select if an oxygen-trim loop is needed. In another application, the CSE can enable/disable control logic for various auxiliaries such as turbine start/stop control, turbine speed control, lube oil pressure and temperature control, amongst others. Based on the data entered and the options selected by the CSE, the computer software program may automatically generate field-proven process controller configurations. The computer software program may generate configurations with advanced function blocks for high speed and high performance controller logic. Following the generation of the controller configuration, the computer software program may automatically generate graphics from existing and new computer software program generated controller configurations.

### BRIEF DESCRIPTION OF THE DRAWINGS

For a better understanding of the nature and object of the present invention reference should be had to the following drawings in which like parts are given like reference numerals and wherein:

FIG. 1 is a flow chart of the computer software package;

FIG. 2 is an embodiment of a screen of the computer software package;

FIG. 3 is an embodiment of a screen of the computer software package;

FIG. 4 is an embodiment of a screen of the computer software package;

FIG. 5 is an embodiment of a screen of the computer software package;

FIG. 6 is an embodiment of a screen of the computer software package;

FIG. 7 is an embodiment of a screen of the computer software package;

FIG. 8 is an embodiment of a screen of the computer software package;

FIG. 9 is an embodiment of a screen of the computer software package;.

FIG. 10 is an embodiment of a screen of the computer software package; and

FIG. 11 is an embodiment of a screen of the computer software package.

### DETAILED DESCRIPTION OF THE INVENTION

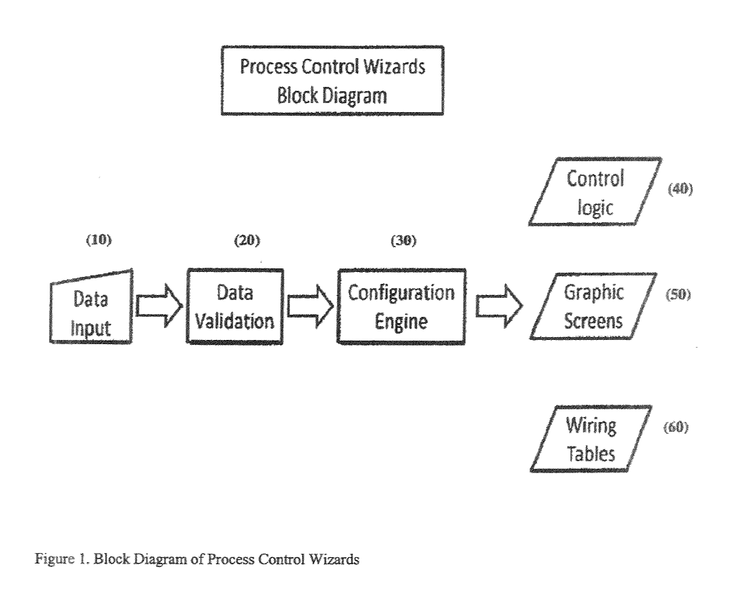

The computer software package or program, also hereinafter referred to as the “Process Control Wizards,” follows the flow chart shown in FIG. 1. After the program accepts the process data (10), it is validated through the Data Validation block (20) by checking against a range of valid values for each parameter. The “Configuration Engine” (30) generates a controller configuration for the application and then customizes this configuration for the process application. The unique “Configuration Engine” block (30) is able to identify and configure all the necessary programs/loops that are needed for each application and generate optimized control logic from a database of field-tested and proven programs. The output of the computer software program consists of three main entities: Control Logic (40), a field proven controller configuration customized for the plant's process; Graphics screens (50) which will enable an operator to control the plant equipment; and Wiring tables (60) that will let a technician wire the controller input/output (I/O) as expected by the controller configuration.

The computer software program may be designed to configure controllers, such as those made by Micon Systems LLC (hereinafter referred to as “MICON”) of Houston, Texas, for any desired process control application. An example of a preferred application is the control of large centrifugal compressors. The compressor control strategies exist in the Process Control

Wizards software program as pre-configured logic.

The screens depicted in FIGS. 1-11 show the Compressor Project Wizard available with MICONView as an example. The Process Control Wizards is comprised of a sequence of easy to understand screens where the user enters the data relevant to the project. These screens belong to block (10)—the “Data Input” block—of the block diagram shown in FIG. 1. Based on the data entered, the Process Control Wizard generates the controller configuration logic for the project. This logic interfaces the controller hardware with the physical process that is to be controlled and operated. The Process Control Wizards also automatically generate the graphics, trends, alarms definitions, faceplates for all loops with trends, group displays, and overview pictures.

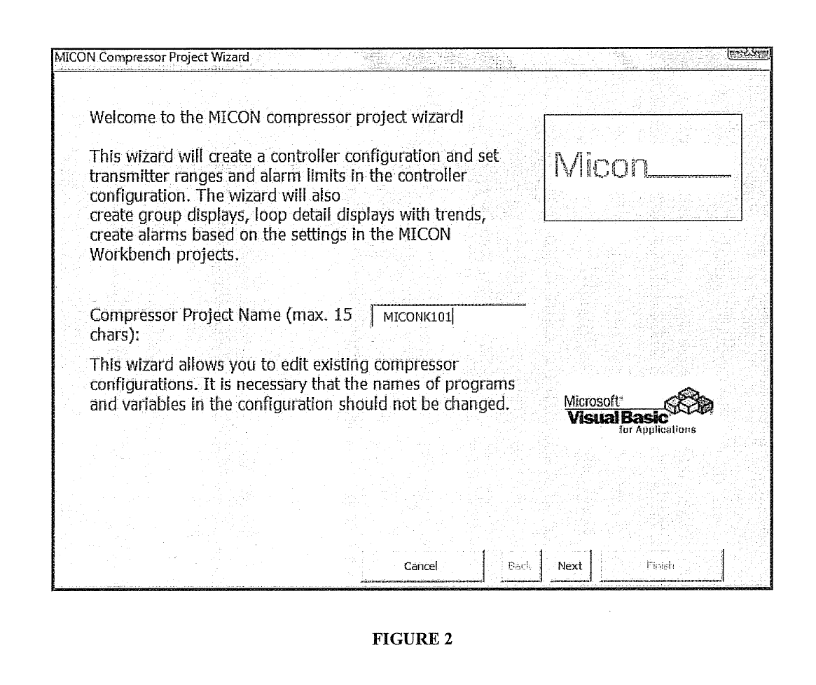

FIG. 2 shows the “Introduction” screen of the Compressor Project Wizard. This screen allows the CSE to enter a project name and informs that CSE of all the features of the Process Control Wizard.

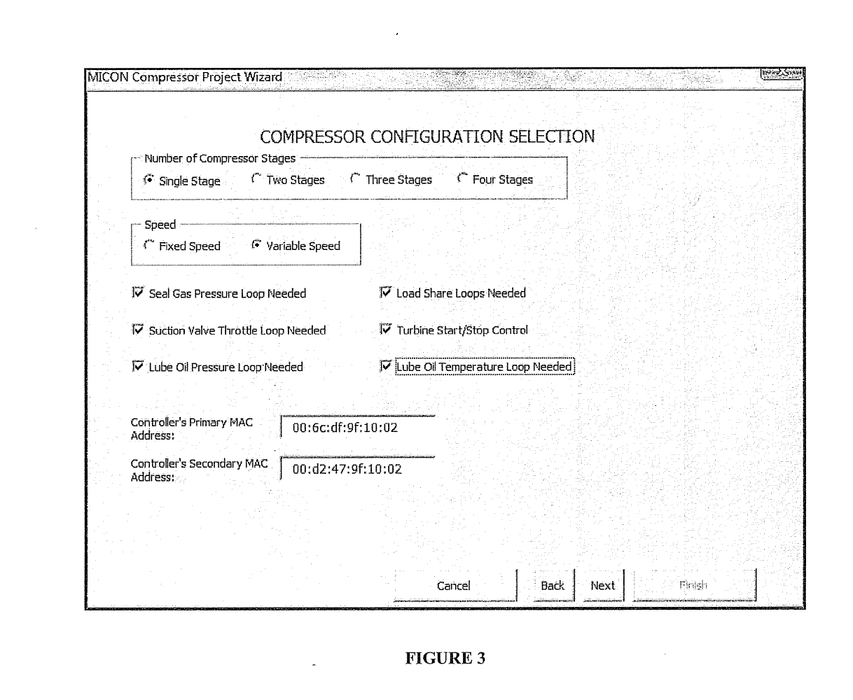

The next page of the Process Control Wizard shown in FIG. 3 permits the CSE to enter the project configuration. For a MICON boiler project wizard, the CSE would choose between a gas-fired boiler or a coal-fired boiler and whether an 02-Trim loop is desired. For the example of centrifugal compressors, the user will select the number of stages and which auxiliary loops are desired. One MICON controller module, for example, has enough I/Os to incorporate a two-stage compressor with most of the auxiliary loops or a four-stage compressor's anti-surge and incipient surge control without any auxiliary loops. The incipient surge loop is preferably selected as part of the control strategy. The incipient surge loop monitors the fluctuations in the flow signal and based on the vibrations, it will signal a possible condition of incipient surge.

The Process Control Wizard can also generate the programs/loops for turbine start and stop control. Because the MICON controller, for example, includes pulse input capability on three of its inputs, the turbine speed can be provided to the controller on its pulse inputs using a magnetic pickup.

As can be seen from this description, the Process Control Wizards uniquely generate field-tested and proven program/logic for an application independent of which options are selected by the CSE.

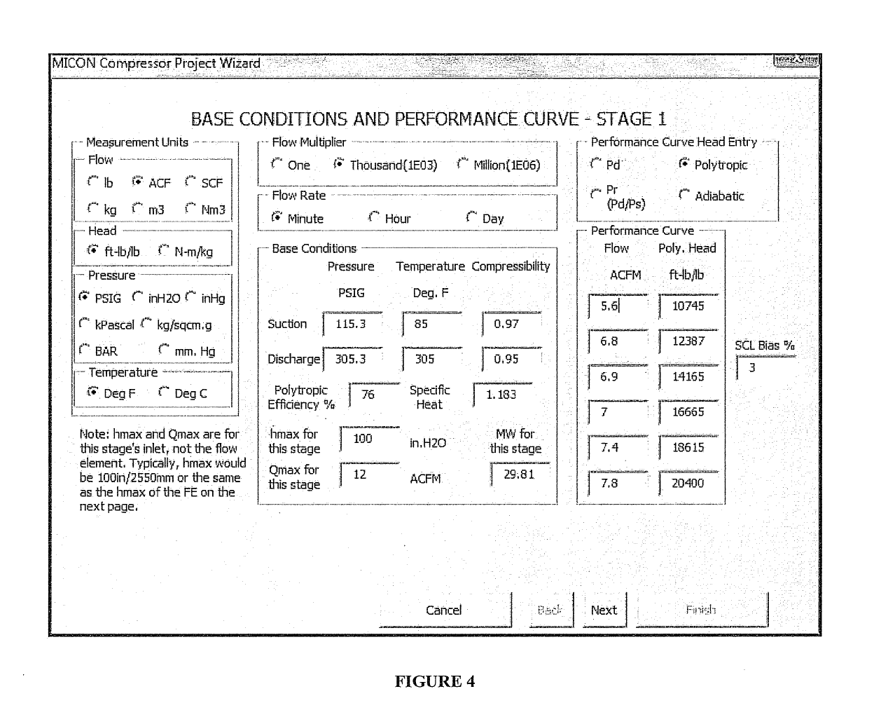

FIG. 4 shows the next page of the MICON Compressor Project Process Control Wizard. Process Control Wizards allow the engineer to enter the base conditions and the performance curve. This graphic is also a part of block (10)—the “Data Input” block—of the block diagram of the Process Control Wizards. In this example, the performance curve is obtained from the compressor vendor. The Process Control Wizards support a multitude of units for flow, head, pressure, and temperature. Note that the Qmax value entered in FIG. 4 is the maximum flow for this stage, and, not the maximum flow obtained from the orifice datasheet. The performance curve entry is done using up to seven data points. Not all seven data points have to be entered.

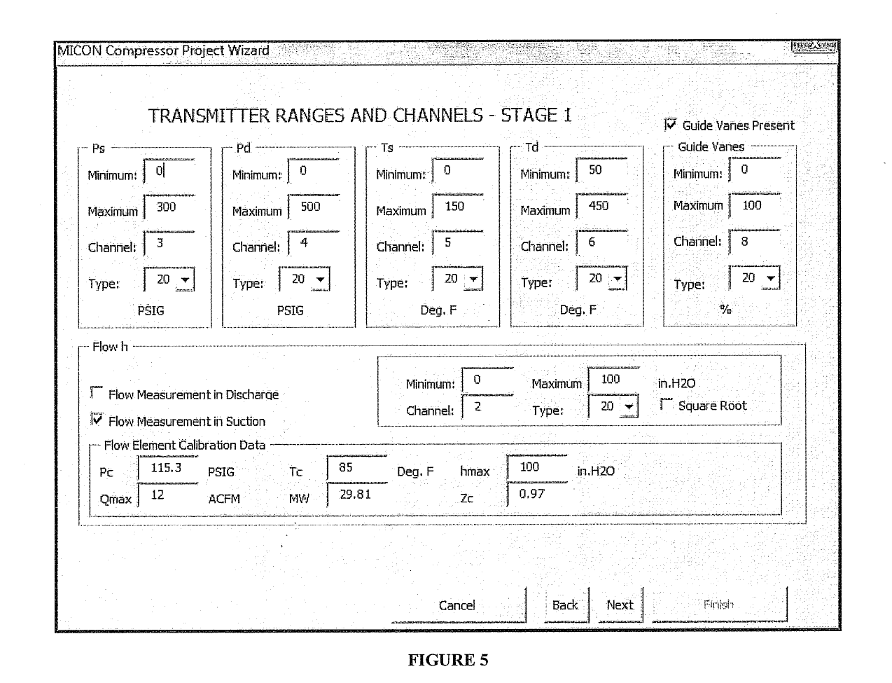

On all Process Control Wizards, the CSE will enter the channel/input numbers, channel types and ranges for the physical quantities such as suction pressure and temperature, discharge pressure and temperature, flow, and guide vanes if present. FIG. 5 is an example from the Compressor Project Process Control Wizard. The Process Control Wizard supports all possibilities for the location of flow measurement—suction, discharge, and sidestream (for multistage projects). The flow element calibration data is also to be entered on this page.

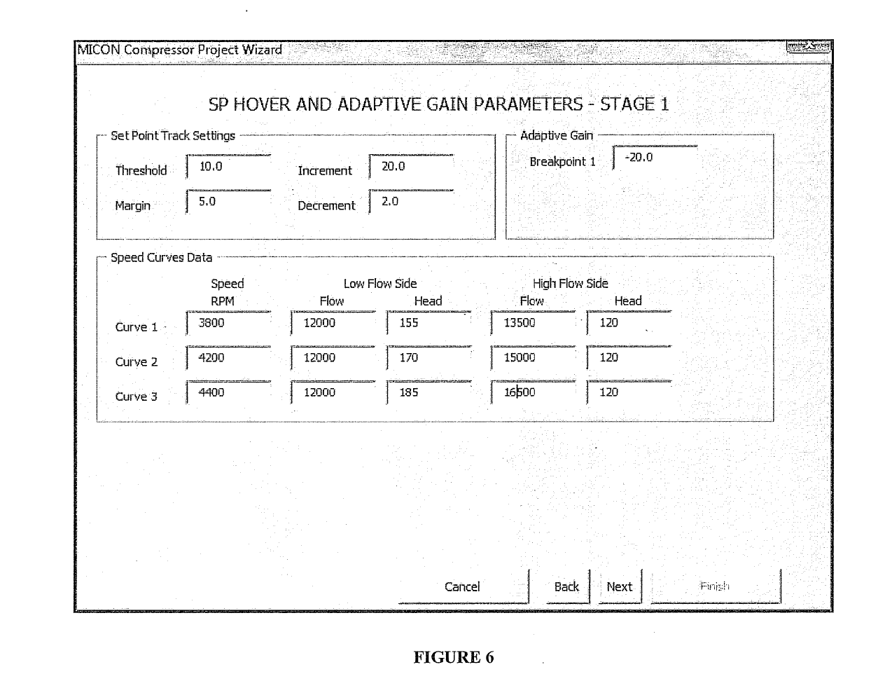

Each project wizard needs certain high-level function blocks that are specific to the equipment being controlled. For the example of the Compressor Project wizard, this includes high-level functions called Set Point Hover and Adaptive Gain for the anti-surge loop. FIG. 6 provides an example of the configuration parameters for these function blocks.

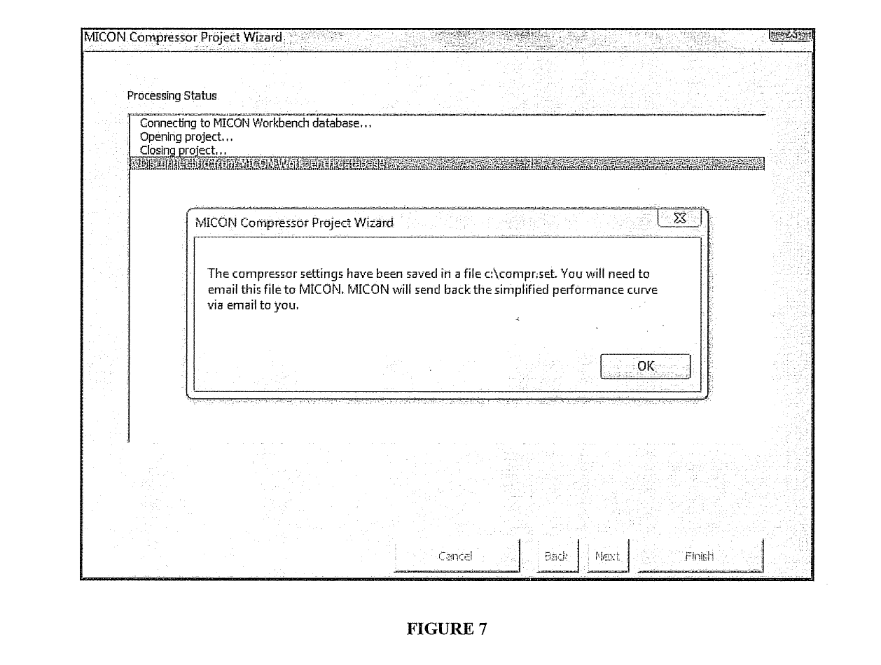

In FIG. 7, all Process Control Wizards validate the data entered by the CSE. This is in reference to block (20)—“Data Validation” block—of the block diagram shown in FIG. 1. The Process Control Wizards save the settings in a file for this project after validation. For some project Process Control Wizards, advanced software tools may be used to further validate the data.

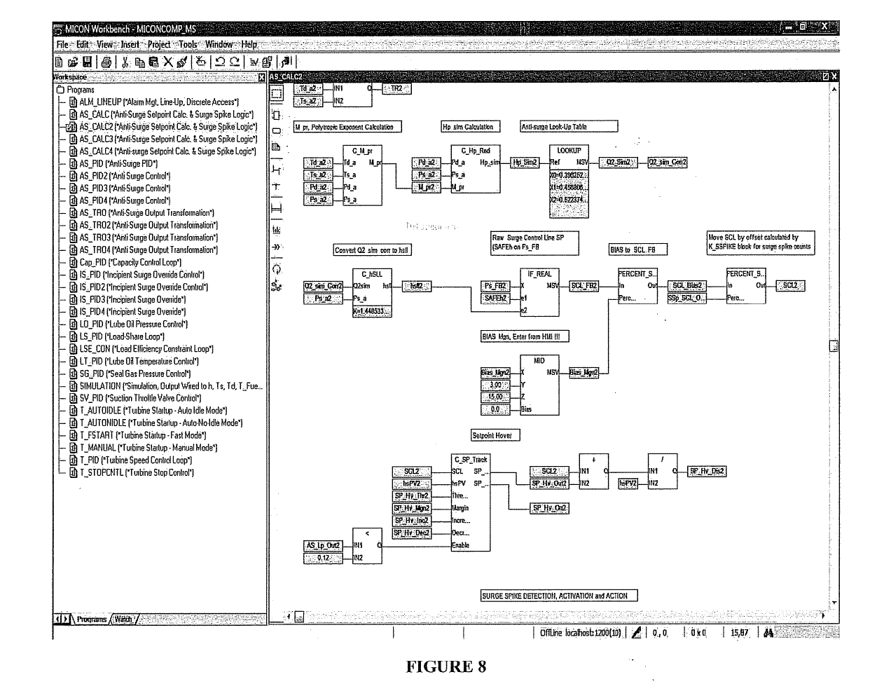

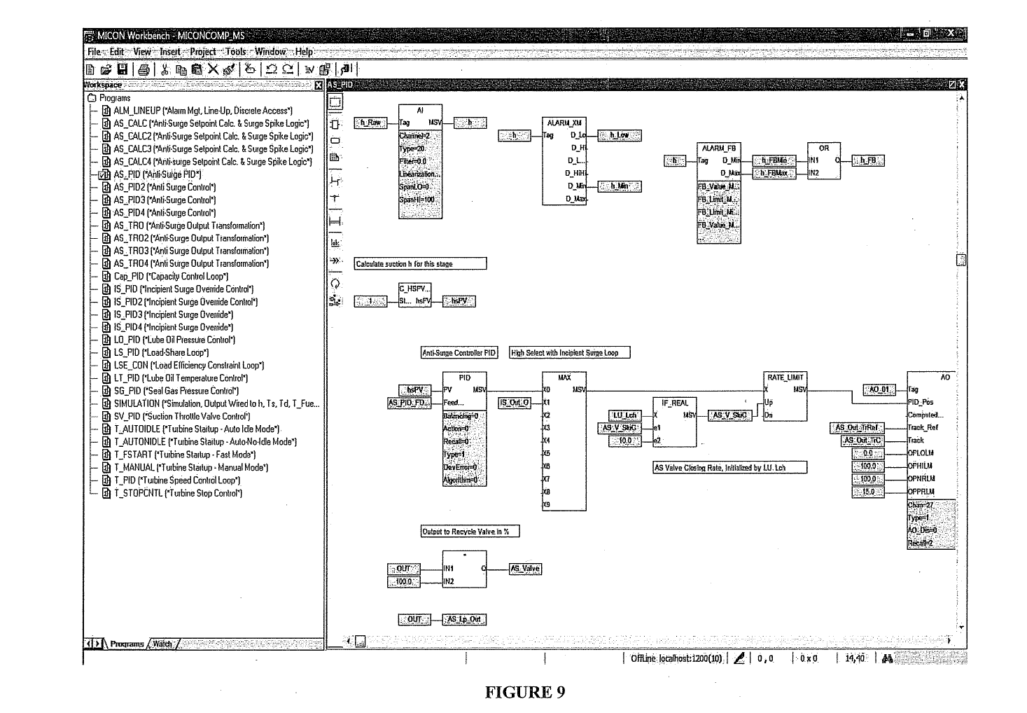

The data entered by the CSE has to be within normal expected ranges. The Process Control Wizard validates the data for this and other requirements. Then, the Process Control Wizards generate the controller configuration for the project. This configuration uses MICON controller function blocks that are specialized for each application type. Advanced function blocks perform multiple functions in an efficient manner and provide logic which improves the controllability of the equipment. For example, for the Compressor Project wizard, advanced functions as Set Point Tracking, Auto Flow Calculation, Surge Spike Detection, Decouple (for decoupling of anti-surge and capacity loops), amongst others are included in the controller configuration generated by the Process Control Wizards The two graphics in FIGS. 8 and 9 show the advanced function. These graphics belong to block (40)—“Control Logic”—of the block diagram shown in the block diagram of FIG. 1.

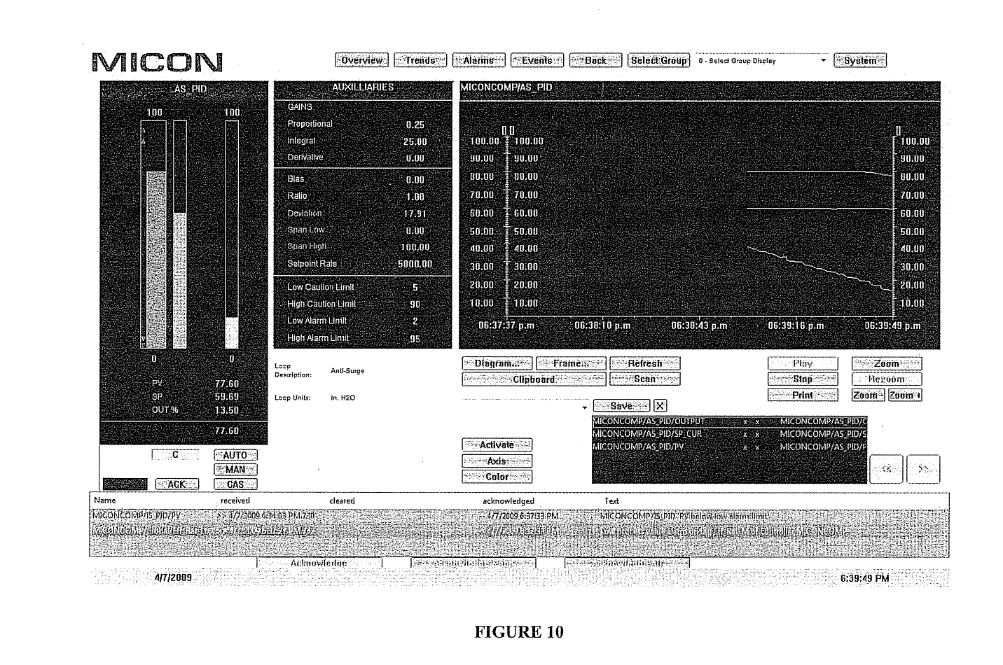

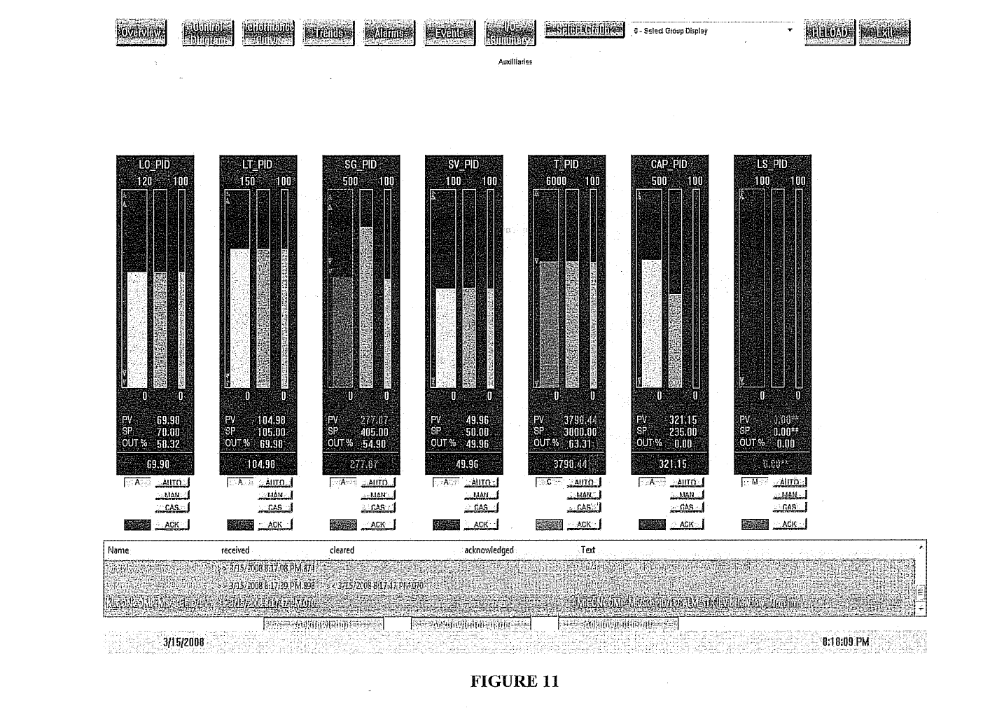

The Process Control Wizards automatically generate the graphics screens to represent and control the plant's process. This relates to block (50)—“Graphic Screens”—of the block diagram shown in FIG. 1 below. For example, the Compressor Project wizard may generate the following graphics screens:
a) A compressor graphic with a recycle valve and data for suction and discharge conditions.
b) A trend screen that allows a plant operator plot a series of variables over time.
c) An alarm screen that displays all the alarms with the time of occurrence, state (acknowledged or not), and a text description for the alarm.
d) Loop detail screen for each loop in the controller configuration with a trend showing the PV, SP and Output of the loop.
e) Group display screens that show a group of predefined loop faceplates.
f) A performance curve display that shows an x-y plot of the surge curve, operating line and a hover line.
g) I/O summary screen that shows all the POs associated with the project.
   The two graphics in FIGS. 10 and 11 are representative of the displays mentioned above.

The current invention automates the development of plant automation programs. The current invention will not only generate graphics, but it will also generate the control logic for the control system application based on answers provided by the CSE in a series of easy to understand forms and steps. The invention relates to the control systems used in industrial and process control, and more particularly to digital control systems. The current invention minimizes the task of the CSE by providing the CSE with a typical and field-proven configuration for the DCS that can be customized with minimal changes for the CSE's plant process.

The Process Control Wizards computer software program collects from the Controls System Engineer (CSE), through a series of easy-to-understand and structured data entry forms, all information relevant to the process that is to be controlled. In addition to entering process data, the CSE selects which auxiliaries are present in the process and if control logic is to be generated for those auxiliaries, The wizards then automatically generate a tested and field-proven configuration for a process controller. This relieves the CSE from having to learn and create the custom-programming interface of a process controller. The CSE only has to be familiar with his process data such as transmitter ranges, settings at which alarms are to be generated, machine information (such as compressor performance curve as provided by the compressor manufacturer and the like), etc. The Process Control Wizards also use advanced function blocks relevant to the process that is to be controlled so that the logic is optimized for speed and performance.

The wizard computer program software technology also is able to automatically generate industry standard HMI screens from existing or wizard generated controller configurations. The screens include process graphics, loop faceplates, loop detail views, event and alarms screens, diagnostics displays, and, trend views. This aspect of the wizard computer program technology eliminates the need for a CSE from having to perform tedious tasks of generating standard graphics.

The Process Control Wizards also will generate physical identification of the hardware termination points where the input and output wiring is to be connected, facilitating the generation of installation drawings and identification of the input and output signals.

The foregoing disclosure and description of the invention are illustrative and explanatory thereof, and various changes in the details of the illustrated apparatus and system, and the construction and method of operation may be made without departing from the spirit of the invention.

I claim:

1. A computer implemented method for generating control system logic comprising the steps of:
providing a computer software program for generating control system logic,
inputting process data;
validating said process data; and
generating a controller configuration with said validated process data.

2. The method of claim 1, further comprising the step of:
customizing said controller configuration for a process application.

3. The method of claim 1, further comprising the step of:
generating graphics screens for controlling plant equipment.

4. The method of claim 3, wherein said graphics screens comprising a compressor graphic.

5. The method of claim 3, wherein said graphics screens comprising a trend screen graphic.

6. The method of claim 1, further comprising the step of:
generating wiring tables for the wiring of a controller input and output pursuant to said controller configuration.

7. The method of claim 1, wherein said process data comprising transmitter ranges.

8. The method of claim 1, wherein said process data comprising settings at which alarms are to be generated.

9. The method of claim 1, wherein said process data comprising machine information.

10. A computer implemented method for generating control system logic comprising the steps of
providing a computer software program for generating control system logic, wherein said computer software program displaying data entry forms;
inputting process data into said data entry forms; and
generating process control configurations from said process data.

11. The method of claim 10, further comprising the step of
generating graphics from said process data.

12. The method of claim 11, wherein said graphics comprising a compressor graphic.

13. The method of claim 11, wherein said graphics comprising a trend screen graphic.

14. The method of claim 10, wherein said process data comprising transmitter ranges.

15. The method of claim 10, wherein said process data comprising settings at which alarms are to be generated.

16. The method of claim 10, wherein said process data comprising machine information.

17. The method of claim 10, wherein said displaying of data entry forms in a defined sequence.

18. The method of claim 10, wherein said computer software program displaying data entry forms for input of optional process equipment.

19. A system for generating control system logic comprising:
a processor; and
a computer software program for generating control system logic, wherein said computer software program displaying data entry forms for process data.

20. The system of claim 19, wherein said computer software program generating control system logic from process data input into said data entry forms.
